(19) United States
(12) Patent Application Publication
(10) Pub. No.: US 2002/0183411 A1
(43) Pub. Date: Dec. 5, 2002

(54) EB-curable optical fiber coating material and curing method

(76) Inventors: Toshio Ohba, Annaka-shi (JP); Nobuo Kawada, Annaka-shi (JP); Masaya Ueno, Annaka-shi (JP); Masatoshi Asano, Annaka-shi (JP); Shigeru Konishi, Annaka-shi (JP)

Correspondence Address: BIRCH STEWART KOLASCH & BIRCH, PO BOX 747, FALLS CHURCH, VA, 22040-0747, US

(21) Appl. No.: 10/131,096

(22) Filed: Apr. 25, 2002

(30) Foreign Application Priority Data
Apr. 25, 2001 (JP) 2001-127851

(51) Int. Cl. C08G 2/00; C08F 2/46; C08J 3/28

(52) U.S. Cl. 522/35; 522/39; 522/51; 522/49; 522/57; 522/96; 522/90; 522/114

(57) ABSTRACT

An optical fiber coating material is provided in the form of an electron beam-curable resin composition comprising a polyurethane having at least two ethylenically unsaturated groups, a reactive diluent, and a compound having both nitrogen and sulfur atoms. The optical fiber coating material is sufficiently EB curable to minimize the dependency of gel fraction and Young's modulus on an EB dose and to comply with the high-speed drawing of optical fiber. The coating material is cured with EB under specific conditions to achieve a sufficient degree of cure and uniform properties without adversely affecting the transmission loss of the optical fiber.

This invention relates to electron beam-curable coating materials for optical fibers including primary and secondary coating materials, and a method of curing the same with electron beams.

### BACKGROUND OF THE INVENTION

Optical communications fibers include a variety of types such as quartz glass, multi-component glass and plastic fibers. In reality, quartz glass fibers are vastly used in a wide variety of applications because of their light weight, low loss, high durability and high transmission capacity. Since quartz glass fibers are very thin and sensitive to external factors, they are generally provided with a two-layer resin coating including a primary soft coat layer and a secondary hard coat layer. In a typical process, immediately after a quartz glass fiber is spun from a melt, a liquid curable resin (to form a soft coat when cured) is applied and cured thereto to form a primary coating. Another liquid curable resin (to form a hard coat when cured) is applied and cured to the primary coating to form a secondary coating for protection. A tape element is fabricated by bundling several, typically four or eight, coated optical fibers and coating the bundle with a taping material, followed by curing.

Typical of the coating materials are urethane acrylate base ultraviolet-curable resin compositions. As disclosed in JP-B 1-19694 and Japanese Patent Nos. 2,522,663 and 2,547,021, liquid UV-curable resin compositions comprising a urethane acrylate oligomer, a reactive diluent, and a photo-polymerization initiator are known.

Japanese Patent No. 2,541,997 discloses electron beams (EB) as exemplary active energy radiation while no reference is made to the voltage for accelerating electron beams. The electron beam curing technology gives rise to the problem that if electron beams which are accelerated at high voltages as are customarily in the art are irradiated to the coating material on optical fiber cores which have been doped with a dopant for increasing an index of refraction, the dopant can be altered or blackened, undesirably resulting in an increased transmission loss. On the other hand, when electron beams are irradiated to optical fiber coatings, the depth of electron penetration depends on the accelerating voltage of electron beams. At too low an accelerating voltage, only a surface layer of resin coating is cured. A further problem arises from the fact that electron beams have great energy. With a large absorption dose, crosslinking occurs at sites other than radical polymerizable functional groups. It is then necessary to control the accelerating voltage and the absorption dose of electron beams simultaneously in order to provide cured products with uniform properties.

### SUMMARY OF THE INVENTION

An object of the invention is to provide an electron beam-curable optical fiber coating material which effectively cures upon exposure to a low dose of electron beams (EB) even in the absence of a photopolymerization initiator. Another object of the invention is to provide a method for curing the optical fiber coating material with electron beams to achieve a high degree of cure and uniform cured properties without exacerbating the transmission loss of the optical fiber.

We have found that the cure of an EB-curable optical fiber coating material can be improved by adding thereto a compound having a nitrogen atom and a sulfur atom in a molecule, so that the coating material effectively cures upon exposure to electron beams in a low dose. This is achieved without detracting from the mechanical properties required as the optical fiber coating including Young's modulus, elongation and strength and the amount of hydrogen gas evolution. Rather, these properties are improved by properly adjusting the concentration of the compound having a nitrogen atom and a sulfur atom in a molecule.

We have further found that since the absorption dose of electron beams is determined by the current flow through the filament and the processing speed, the dose can be made constant by controlling the current flow in proportion to the fiber drawing speed. More particularly, electron beams are generally produced by conducting electric current through a filament to heat the filament for thermionic emission, and accelerating the electrons at a voltage (accelerating voltage). When electron beams are irradiated to optical fiber coatings, the accelerating voltage affects the depth of electron penetration. If the accelerating voltage is too low, only a surface layer of the resin coating is cured. Since electron beams have great energy, a large dose can cause crosslinking to occur at sites other than radical polymerizable functional groups. It is then necessary to control both the accelerating voltage and the dose of electron beams in order to provide cured coatings with uniform properties. Based on these observations, we have discovered that better results are obtained when an EB-curable resin composition containing a compound having a nitrogen atom and a sulfur atom in a molecule, especially an EB-curable resin composition containing a polyurethane having at least two ethylenically unsaturated groups in a molecule, a thiourea, thiazole or imidazole compound having both a nitrogen atom and a sulfur atom in a molecule, and a reactive diluent is used as the optical fiber coating material, and when the coating material is applied onto an optical fiber to form a coating of 20 to 200 μm thick, and electron beams, produced by accelerating electrons at a voltage of 50 to 190 kV, are directed to the coating in a dose of 5 to 100 kGy.

It is noted that JP-A 62-215663 discloses an optical fiber coating composition comprising a sulfur-containing antioxidant, which composition is effective for suppressing the evolution of hydrogen gas. It does not refer to whether this antioxidant is effective for promoting the cure when the composition is cured with electron beams. WO 98/385401 proposes an optical fiber binding material or taping material comprising a nitrogen and sulfur-containing compound, which material is effective for reducing the entrainment of bubbles upon UV curing. It does not refer to whether this compound is effective for promoting the cure by electron beam irradiation.

Therefore, the present invention provides an electron beam-curable optical fiber coating material comprising an electron beam-curable resin composition containing a compound having a nitrogen atom and a sulfur atom in a molecule. The preferred electron beam-curable resin composition contains the compound having a nitrogen atom and a sulfur atom in a molecule, a polyurethane having at least two ethylenically unsaturated groups in a molecule, and a reactive diluent.

According to the method of the invention, the electron beam-curable optical fiber coating material is cured by applying the material onto an optical fiber to form a coating of 20 to 200 μm thick, and irradiating electron beams, produced by accelerating electrons at a voltage of 50 to 190 kV, to the coating in a dose of 5 to 100 kGy.

### DESCRIPTION OF THE PREFERRED EMBODIMENTS

The EB-curable optical fiber coating material of the present invention contains a compound having a nitrogen atom and a sulfur atom in a molecule. Any compound having a nitrogen atom and a sulfur atom in a molecule may be used as long as it is effective for improving the cure of the EB-curable optical fiber coating material upon exposure to electron beams. Among others, thiourea, thiazole and imidazole compounds having both a nitrogen atom and a sulfur atom in a molecule are preferred because of their cure improving effects.

Suitable thiourea compounds include ethylenethiourea, N,N-diethylthiourea, N,N-dibutylthiourea, and trimethylthiourea. Exemplary thiazole compounds are 2-mercaptobenzothiazole, dibenzothiazyldisulfide, the cyclohexylamine salt of 2-mercaptobenzothiazole, and the zinc salt of 2-mercaptobenzothiazole. Exemplary of the imidazole compound is 2-mercaptobenzimidazole.

The desired content of the compound having a nitrogen atom and a sulfur atom in a molecule is 0.1 to 10% by weight based on the EB-curable resin composition. Less than 0.1% by weight of the compound may fail to fully exert the cure improving effect whereas more than 10% of the compound may detract from the cured properties. The more desired content of the compound is 0.3 to 5% by weight.

In one preferred embodiment of the invention, the EB-curable resin composition contains a polyurethane having at least two ethylenically unsaturated groups in a molecule in addition to the compound having a nitrogen atom and a sulfur atom in a molecule.

The polyurethane having at least two ethylenically unsaturated groups in a molecule is obtained, for example, by reacting a diisocyanate with a compound having an ethylenically unsaturated group, or by reacting a diol comprising a C₂₋₁₀ oxyalkylene group and having a number average molecular weight (Mn) of 800 to 10,000 with a diisocyanate and a compound having an ethylenically unsaturated group. If the diol containing an oxyalkylene group has a Mn of less than 800, the cured film lacks elongation. If the diol comprising an oxyalkylene group has a Mn of more than 10,000, the polyurethane becomes less curable by electron beam irradiation.

Examples of the diol containing a C₂₋₁₀ oxyalkylene group include polyethylene glycol, polypropylene glycol, polytetramethylene glycol, 2-methyltetrahydrofuran glycol, 3-methyltetrahydrofuran glycol, polyheptamethylene glycol, polyhexamethylene glycol, polydecamethylene glycol, and polyalkylene oxide added diol of bisphenol A. Preferred from the standpoints of water absorption and viscosity are polypropylene glycol, polytetramethylene glycol, 2-methyltetrahydrofuran glycol, and 3-methyltetrahydrofuran glycol. The polyalkylene oxides may be used in the form of homopolymers as well as random and block copolymers.

Examples of the diisocyanate include 2,4-toluene diisocyanate, 2,6-toluene diisocyanate, 1,3-xylene diisocyanate, 1,4-xylene diisocyanate, 1,5-naphthalene diisocyanate, m-phenylene diisocyanate, p-phenylene diisocyanate, hexamethylene diisocyanate, isophorone diisocyanate, 2,2,4-trimethylhexamethylene diisocyanate, and 2,4,4-trimethylhexamethylene diisocyanate. Of these, 2,4-toluene diisocyanate is preferred because of better properties, availability and low cost. These diisocyanates may be used alone or in admixture of two or more.

The compounds having an ethylenically unsaturated group include (meth)acrylic compounds having hydroxyl, acid halide or epoxy groups. Examples of suitable (meth)acrylic compounds having hydroxyl groups include 2-hydroxyethyl (meth)acrylate, 2-hydroxypropyl (meth)acrylate, pentaerythrithol tri(meth)acrylate, and glycerin di(meth)acrylate as well as addition products of glycidyl group-containing compounds such as alkyl glycidyl ethers and glycidyl (meth)acrylate with (meth)acrylic acid. Examples of suitable (meth)acrylic compounds having acid halide groups include (meth)acrylic acid chloride and (meth)acrylic acid bromide. Examples of suitable (meth)acrylic compounds having epoxy groups include glycidyl esters of (meth)acrylic acid.

The polyurethane having two ethylenically unsaturated groups in a molecule is produced, for example, by reacting the diol with the diisocyanate in a molar ratio OH/NCO of from 1/2 to 2/1 in a conventional manner, followed by reaction with the ethylenically unsaturated group-containing compound.

If a composition consisting of the polyurethane and the compound having nitrogen and sulfur atoms in a molecule has too high a viscosity to apply, it is desirably diluted with a reactive diluent. The reactive diluent is any compound having a functional group capable of radical polymerization upon exposure to electron beams, desirably a compound having in a molecule at least one (meth)acryloyl group having a high radical polymerization capability.

Illustrative examples of the compounds having one acryloyl group per molecule include methoxyethylene glycol (meth)acrylate, methoxypolyethylene glycol (meth)acrylate, nonylphenoxyethyl (meth)acrylate, nonylphenoxypolyethylene glycol (meth)acrylate, nonylphenoxypolypropylene glycol (meth)acrylate, 3-chloro-2-hydroxypropyl (meth)acrylate, phenoxyethyl (meth)acrylate, phenoxypolypropylene glycol (meth)acrylate, butoxypolyethylene glycol (meth)acrylate, alkyl (meth)acrylates, cyclohexyl (meth)acrylate, tetrahydrofurfuryl (meth)acrylate, isobornyl (meth)acrylate, benzyl (meth)acrylate, cumylphenol (meth)acrylate, cumylphenoxypolyethylene glycol (meth)acrylate, cumylphenoxypolypropylene glycol (meth)acrylate, 2-hydroxypropyl (meth)acrylate, 2-ethylhexyl (meth)acrylate, dicyclopentadiene (meth)acrylate, 2-hydroxy-3-phenoxypropyl (meth)acrylate, 2-(meth)acryloyloxyethyl-2-hydroxyethyl phthalic acid, 3-acryloyloxyglycerin mono(meth)acrylate, 2-hydroxybutyl (meth)acrylate, 2-hydroxy-1-(meth)acryloxy-3-(meth)acryloxypropane, polypropylene glycol mono(meth)acrylate, polyethylene glycol mono(meth)acrylate, poly-e-caprolactone mono(meth)acrylate, dialkylaminoethyl (meth)acrylates, glycidyl (meth)acrylate, mono[2-(meth)acryloyloxyethyl] acid phosphate, trichloroethyl (meth)acrylate, 2,2,3,3-tetrafluoropropyl (meth)acrylate, 2,2,3,4,4,4-hexafluorobutyl (meth)acrylate, perfluorooctylethyl (meth)acrylate, dicyclopentenyl (meth)acrylate, dicyclopentenyloxyalkyl (meth)acrylates, tricyclodecanyl (meth)acrylate, tricyclodecanyloxyethyl (meth)acrylate, isobornyloxyethyl (meth)acrylate, and morpholine (meth)acrylate.

Examples of the compounds having two acryloyl groups per molecule include the di(meth)acrylate of 2,2-dimethyl-3-hydroxypropyl-2,2-dimethyl-3-hydroxypropionate, ethylene glycol di(meth)acrylate, tetraethylene glycol di(meth)acrylate, polyethylene glycol di(meth)acrylate, propylene glycol di(meth)acrylate, polypropylene glycol di(meth)acrylate, 1,4-butane diol di(meth)acrylate, 1,6-hexane diol di(meth)acrylate, glycol di(meth)acrylate, neopentyl glycerin di(meth)acrylate, the di(meth)acrylate of bisphenol A-ethylene oxide adduct, the di(meth)acrylate of bisphenol A-propylene oxide adduct, 2,2′-di(hydroxyethoxy-phenyl)propane di(meth)acrylate, tricyclodecane dimethylol di(meth)acrylate, dicyclopentadiene di(meth)acrylate, pentane di(meth)acrylate, and the (meth)acrylic acid adduct of 2,2-bis(glycidyloxyphenyl)propane.

Illustrative examples of the compounds having at least three acryloyl groups per molecule include trimethylol propane tri(meth)acrylate, trimethylol propane trioxyethyl(meth)acrylate, pentaerythritol tetra(meth)acrylate, dipentaerythritol hexa(meth)acrylate, tris(acryloxymethyl) isocyanurate, tris(acryloxyethyl) isocyanurate, tris(acryloxypropyl) isocyanurate, and triallyl trimellitic acid and triallyl isocyanurate.

Besides the (meth)acryloyl group-bearing compounds, there may be used N-vinyl compounds having a radical polymerization capability such as N-vinylpyrrolidone, N-vinylcaprolactam, N-vinylacetamide, and N-vinylformamide. These reactive diluents may be used alone or in admixture of two or more.

An appropriate amount of the reactive diluent is 5 to 200 parts by weight per 100 parts by weight of the polyurethane having at least two ethylenically unsaturated groups in a molecule.

If desired, the optical fiber coating material of the invention may contain additives in addition to the above components as long as the objects of the invention are not impaired. Such additives include sulfur and phenolic antioxidants, organic solvents, plasticizers, surfactants, silane coupling agents, coloring pigments, and organic or inorganic particles.

The optical fiber coating material of the invention can be prepared by blending the above components, followed by agitation mixing. From the working standpoint, the material is desirably adjusted to a viscosity of 500 to 10,000 mPa-sec at 25° C. for compatibility with conventional manufacturing conditions of optical fibers and especially 500 to 4,000 mPa-sec at 25° C. for compatibility with high speed manufacturing conditions.

When used as the primary coating, the optical fiber coating material of the invention is directly applied and cured to the optical glass fiber to form a cured film therearound. To protect the optical fiber from microbending due to external stresses and temperature changes, the primary coating material should preferably have a Young's modulus of up to 5 MPa. When used as the secondary coating applied to the primary coating for mechanical protection of the optical fiber, the coating material should preferably have a Young's modulus of at least 30 MPa.

According to the invention, the coating material prepared by mixing the above components is applied to the optical fiber as by die coating to form a coating of 20 to 200 Mm thick, desirably 30 to 60 μm thick. Electrons are accelerated at a voltage of 50 to 190 kV, desirably 70 to 120 kV to produce electron beams, which are directed to the coating on the optical fiber so as to give an absorption dose of 5 to 100 kGy, desirably 10 to 30 kGy. Then the coating is effectively cured without adversely affecting the properties of the optical fiber including transmission loss. An accelerating voltage of lower than 50 kV fails to achieve the deep cure of the coating material whereas an accelerating voltage of higher than 190 kV can detract from the properties of the optical fiber. A dose of less than 5 kGy leads to under-cure whereas a dose of more than 100 kGy can induce crosslinking reaction somewhere other than ethylenic functional groups, sometimes increasing the Young's modulus beyond the acceptable range.

### EXAMPLE

Examples of the invention are given below by way of illustration and not by way of limitation. All parts are by weight.

### Example 1

A reactor was charged with 106.8 g of nonylphenol EO (4 mol)-modified acrylate Aronix M-113 (Toagosei Co., Ltd.), 17.3 g of 2,4-tolylene diisocyanate, 0.5 g of dibutyltin dilaurate, and 0.15 g of 2,6-di-tert-butylhydroxytoluene. In dry air, 11.3 g of 2-hydroxyethyl acrylate was added dropwise at such a rate as to keep the temperature below 15° C. The mixture was heated at a temperature of 30° C. and allowed to react for 2 hours. Then 398 g of polypropylene glycol having a Mn of 7,950 was added to the mixture, which was kept at 50 to 60° C. for 3 hours for reaction to take place. There was obtained an acrylic urethane oligomer containing 20% by weight of M-113, designated Oligomer A.

A primary coating material was prepared by mixing 125 parts of Oligomer A, 8.3 parts of Aronix M-113, 16.6 parts of lauryl acrylate, 16.6 parts of N-vinyl caprolactam and 0.83 part (0.5 wt %) of 2-mercaptothiazole. It had a viscosity of 4,500 mPa-sec at 25° C.

Using an applicator, the primary coating material was coated onto a glass plate to a thickness of about 60 nm. Electrons were accelerated under a voltage of 100 kV to produce electron beams, which were irradiated to the coating in a dose of 10 to 100 kGy, obtaining a cured film. The curd film was examined by the following tests. The test results are shown in Table 1, indicating that the cured film fully satisfies the requirements as the optical fiber primary coating material. Evaluation of coating properties

(1) Gel fraction

The cured film was immersed in acetone for 16 hours, taken out, dried at 70° C. for 4 hours, and weighed. A weight loss was computed according to the following equation.

Gel fraction=(weight of dry film)/(weight of initial film)×100%

(2) Young's modulus

The cured film was conditioned at 25° C. and RH 50% for 24 hours before a 2.5% tensile modulus (Young's modulus) was measured at a gage mark distance of 25 mm and a pulling rate of 1 mm/min.

(3) Tensile strength and elongation at rupture

The cured film was conditioned at 25° C. and RH 50% for 24 hours before measurement was made at a gage mark distance of 25 mm and a pulling rate of 50 mm/min.

(4) Hydrogen gas evolution

The cured film, about 3 g, was placed in a 500 ml glass vessel, sealed in air, and heated at 120° C. for 48 hours. The hydrogen gas evolved was measured by gas chromatography.

### Comparative Example 1

A primary coating material was prepared as in Example 1, except that 2-mercaptothiazole was omitted. As in Example 1, the coating material was coated and cured with electron beams, and the properties of the cured film examined. The results are shown in Table 1. The coating material of Comparative Example 1 was less curable in low doses and evolved more hydrogen gas as compared with Example 1.

### Example 2

A reactor was charged with a mixture of 51.5 g of 2,4-tolylene diisocyanate, 42.3 g of polytetramethylene ether glycol having a Mn of 2,000, 22.0 g of polyoxypropylene glycol having a Mn of 400, and 1.6 g of trioxypropylene glycol. In a nitrogen atmosphere, reaction was effected at 70 to 80° C. for 3 hours. The reaction mixture was cooled to 40° C., the reactor was purged with dry air, and 50.0 g of 2-hydroxyethyl acrylate was added. The reactor was slowly heated to a temperature of 60 to 700° C., at which reaction was effected for 2 hours. With 0.1 g of dibutyltin dilaurate added, reaction was effected for a further 4 hours, yielding an acrylic urethane oligomer, designated Oligomer B.

A secondary coating material was prepared by admixing 100 parts of Oligomer B, 14.3 parts of isobornyl acrylate, 14.3 parts of N-vinylcaprolactam, 14.3 parts of tricyclodecanedimethanol diacrylate and 1.4 parts (1.0 wt %) of 2-mercaptobenzimidazole. It had a viscosity of 3,900 mPa-sec at 25° C.

As in Example 1, the secondary coating material was coated and cured with electron beams, and the properties of the cured film examined. The results are shown in Table 1, indicating that the cured film fully satisfies the requirements as the optical fiber secondary coating material.

### Comparative Example 2

A secondary coating material was prepared as in Example 2, except that 2-mercaptobenzimidazole was omitted. As in Example 1, the coating material was coated and cured with electron beams, and the properties of the cured film examined. The results are shown in Table 1. The coating material of Comparative Example 2 was less curable in low doses and evolved more hydrogen gas as compared with Example 2.

TABLE 1

| | | | Comparative | | Comparative |
|---|---|---|---|---|---|
| | EB dose | Example | Example | Example | Example |
| Properties | (kGy) | 1 | 1 | 2 | 2 |
| Gel fraction (%) | 10 | 94 | 90 | 97 | 93 |
| | 30 | 95 | 94 | 97 | 97 |
| | 100 | 95 | 95 | 97 | 98 |
| Young's modulus (Mpa) | 10 | 1.3 | 1.0 | 640 | 540 |
| | 30 | 1.5 | 1.5 | 820 | 830 |
| | 100 | 1.5 | 1.5 | 980 | 940 |
| Elongation (%) | 100 | 150 | 150 | 58 | 52 |
| Tensile strength (Mpa) | 100 | 1.4 | 1.3 | 50 | 40 |
| H₂ evolved (μl/g) | 100 | 1.5 | 7.5 | 1.0 | 11.0 |

There has been described an optical fiber coating material which is sufficiently curable with electron beams to minimize the dependency of gel fraction and Young's modulus on a dose and to comply with the high-speed drawing of optical fibers. When the coating material on an optical fiber is irradiated with electron beams under specific conditions, the coating is cured to a sufficient degree of cure and uniform properties without adversely affecting the transmission loss of the optical fiber.

Japanese Patent Application No. 2001-127851 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An electron beam-curable optical fiber coating material comprising an electron beam-curable resin composition containing a compound having a nitrogen atom and a sulfur atom in a molecule.

2. The coating material of claim 1 wherein said electron beam-curable resin composition further contains a polyurethane having at least two ethylenically unsaturated groups in a molecule.

3. The coating material of claim 1 wherein said electron beam-curable resin composition further contains 100 parts by weight of a polyurethane having at least two ethylenically unsaturated groups in a molecule and 5 to 200 parts by weight of a reactive diluent.

4. The coating material of claim 1 wherein said compound is a thiourea, thiazole or imidazole compound.

5. The coating material of claim 1 wherein said compound is contained in an amount of 0.1 to 10% by weight of the composition.

6. A method for curing an electron beam-curable optical fiber coating material according to claim 1, comprising the steps of:
applying the material onto an optical fiber to form a coating of 20 to 200 μm thick, and
irradiating electron beams, produced by accelerating electrons at a voltage of 50 to 190 kV, to the coating in a dose of 5 to 100 kGy.
